(19) United States
(12) Patent Application Publication
(10) Pub. No.: US 2004/0071831 A1
(43) Pub. Date: Apr. 15, 2004

(54) Anatomically correct candy novelty

(76) Inventor: Jason A. Barba, Denver, CO (US)

Correspondence Address: Richard C. Litman, LITMAN LAW OFFICES, LTD., P.O. Box 15035, Arlington, VA, 22215, US

(21) Appl. No.: 10/671,459

(22) Filed: Sep. 29, 2003

Related U.S. Application Data
(63) Continuation-in-part of application No. 10/256,143, filed on Sep. 27, 2002.

(51) Int. Cl. A23G 3/00

(52) U.S. Cl. 426/91

(57) ABSTRACT

An anatomically correct candy novelty made of an exterior layer of confectionery material that represents the skin and flesh of an anatomically correct human body part, and an interior layer of hard candy material that represents the skeleton of the same anatomically correct human body part. The exterior layer of confectionery material is made of a soft confectionery material, such as chocolate, a soft, gelatinous gum, taffy, marshmallow, etc. Instead of an anatomically correct human body part, the candy novelty may be formed as a caricature, such as a Frankenstein head, tiger head, etc. The candy novelty may be mounted on a stick.

### CROSS REFERENCE TO RELATED APPLICATION

This application is a continuation-in-part of my prior application Ser. No. 10/256,143, filed Sep. 27, 2002.

### BACKGROUND OF THE INVENTION

1. Field of the Invention

The present invention relates to an anatomically correct candy novelty. More specifically, the invention includes embodiments of different anatomically correct related body parts that have exterior flesh made of chocolate and other confection with underlying bones made of hard candy. Alternatively, the novelty candy may be formed as a caricature, and the outer layer may be a soft confection other than chocolate, such as a gum-type gelatin, taffy, etc.

2. Description of the Related Art

Children love to eat candy, especially during Halloween. Candy making is a multi-billion dollar industry that requires candy makers to make wholesome as well as imaginative products. Most candy is sugar based and includes various confections such as chocolate, taffy, marshmallow, gum and hard candy. These types of candy are very popular and are well-known in the related art.

U.S. Pat. No. Des. 62,611 issued to Hochstraser, outlines the ornamental design of a face made of hard candy.

U.S. Pat. No. Des. 269,559 issued to Sellares, outlines the ornamental design of a pointing finger made of a confection on a stick.

U.S. Pat. No. 1,913,851 issued to Oprean, outlines a molded or otherwise shaped figure of ice cream covered with chocolate, forming a confection being that of an animal, flower, doll or the like and arranged with or without a support stick. One of the limbs, elements or members of the figure may also be movably connected with the other parts thereof to provide an entertaining feature.

U.S. Pat. No. 2,457,110 issued to Burbank et al., outlines a process of manufacturing chocolate coated edibles for use as a coating for chocolates, candy and ice cream bars. Chocolate liquor is blended with various ingredients such as sugar, cocoa butter, lecithin, flavoring material and in some cases with whole milk solids, skim milk, or buttermilk solids, depending upon the type of chocolate coating desired.

U.S. Pat. No. 4,517,205 issued to Aldrich, outlines a process of making hard candies, and in particular, to hard candy having a comparatively soft center and method of producing a codeposited two-component hard candy having a hard candy shell portion, which may advantageously be of viscous or even liquid material. The two-component hard candy can be efficiently produced by codepositing the core composition in timed sequence with the shell portion composition into a mold cavity in such a manner that the core portion is mixed in the approximate center of the resulting candy unit.

U.S. Pat. No. 4,902,519 issued to Ream et al., outlines a lollipop-type confection which is molded and packaged in an elastic mold together with the method of making such a confection. After the molten candy product is poured through the opening of an elastic mold, the opening is sealed with a layer of chewing gum product. A handle in the form of a stick is also provided in which the stick passes through the layer of the chewing gum product and into the candy product.

U.S. Pat. No. 5,343,710 issued to Cathenaut et al., outlines a method and machine for the production of a decorated article of ice confectionery of the ice lolly type (i.e., water ice, sorbet or two flavored ice cream.). The method is characterized in that the frozen core is produced in a first grooved frustocylindrical mold, after which the core is introduced as a countermold into a second frustocylindrical mold having the same cross-section as that in which the countermold fits, the second mold having been partly filled beforehand with an ice mixture of the second flavor, so that the countermold causes it to ascend into the recessed interstices to form stripes.

U.S. Pat. No. 5,637,344 issued to Carpenter et al., outlines a product and process for preparing an amorphous chocolate flavored hard candy made by air-jet milling cocoa powder under conditions sufficient to produce particles having an average size of less than about 15 microns in diameter and having generally rounded edges. This is made by dissolving an amorphous candy mass made from a sweetener to produce an aqueous solution of the amorphous candy mass, the sweetener being a carbohydrate, sugar alcohol or mixture thereof, and heating the solution under conditions sufficient to convert and maintain the sweetener in the amorphous state. The process also involves mixing a chocolate flavoring effective amount of the aqueous solution of the amorphous candy mass at sufficiently high temperatures to effect the dispersion of the cocoa powder and forming and cooling the product.

French Patent No. 2,764,169 published Dec. 11, 1998, outlines a patterned confectionery process involving forming patterns of a first food paste on a backing foil, sandwiching the backing foil between two plates, with at least one of which having apertures of a predetermined shape aligned with the patterns, pouring a hot second food paste into the apertures and cooling for fixing the patterns in the second food paste to form the patterned confectionery. Preferably, the plates are made of polycarbonate and the backing foil consists of a plastic suitable for food contact.

Although each of the previously discussed patents describes useful and novel candy products or processes for making a useful or novel candy product, there is always room for a creative new candy product in the marketplace. If someone developed a candy product that represented human body parts (i.e., skulls and skeletal body parts.) that was anatomically correct, this idea could be “ghoulish” enough to catch the attention of many children in the candy demographic.

None of the above inventions and patents, taken either singularly or in combination, is seen to describe the instant invention as claimed. Thus an anatomically correct candy novelty solving the aforementioned problems is desired.

### SUMMARY OF THE INVENTION

The invention is an anatomically correct candy novelty made of an exterior layer of confectionery material that represents the skin and flesh of an anatomically correct human body part and an interior layer of hard candy material that represents the skeleton of that same anatomically correct human body part. The human body parts include, for example, a skull and face on a stick, a hand and a thumb on a stick. The exterior layers of confectionery material can also be made of chocolate, marshmallow, taffy, etc.

In a broader aspect, the present invention relates to a multi-layered candy novelty having an interior layer of hard candy and an exterior layer made from a soft confection, such as a gum-type gelatin, taffy, marshmallow, chocolate, etc. Instead of an anatomically correct human body part, the candy may be formed as a caricature, such as a Frankenstein head caricature. The caricature has an exterior layer of gummi bear material that is formed into either a three-dimensional or two-dimensional Frankenstein head caricature with an interior layer of hard candy material that is formed into a two-dimensional or a three-dimensional skeleton head, the exterior layer covering the entire interior layer. The confection may also be formed the shape of a tiger head and skeleton caricature, or other caricature forms.

Accordingly, it is a principal object of the invention to provide related candy body parts that have an anatomically correct chocolate exterior and underlying hard candy skeleton or bone interior.

It is another object of the invention to provide related candy body parts that have an anatomically correct taffy exterior and underlying hard candy skeleton or bone interior.

It is a further object of the invention to provide related candy body parts that have an anatomically correct marshmallow exterior and underlying hard candy skeleton or bone interior.

It is another object of the invention to provide various anatomically correct body parts made with various confection exterior flesh and underlying hard candy skeletal or bone.

It is another object of the present invention to provide a candy novelty formed in multiple layers, including an interior layer made from hard candy, and an exterior layer made from a soft confection, such as a gum-type gelatin, taffy, marshmallow, chocolate, etc.

It is a further object of the invention to provide a multi-layered candy novelty which may be formed as either two-dimensional or three-dimensional anatomically correct human body parts, or as caricatures such as a Frankenstein head, a tiger head, etc.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an anatomically correct candy novelty according to the present invention.

FIG. 2 is a side perspective view of a clown face on a stick made with a confectionery exterior skin and an underlying hard candy skull and an isolated hard candy skull.

FIG. 3 is a front perspective view of a human hand made with a confectionery exterior skin and underlying hard candy skeletal bones.

FIG. 4 is a front perspective view of a human thumb on a stick made with confectionery exterior skin and an underlying hard candy thumb bone.

FIG. 5 is a front perspective view of an embodiment of a multi-layered candy novelty Frankenstein head caricature according to the present invention.

FIG. 6 is a section view along lines 6-6 of FIG. 5.

FIG. 7 is a front perspective view of an embodiment of a multi-layered candy novelty tiger head caricature.

FIG. 8 is a section view along lines 8-8 of FIG. 7.

Similar reference characters denote corresponding features consistently throughout the attached drawings.

### DETAILED DESCRIPTION OF THE PREFERRED EMBODIMENTS

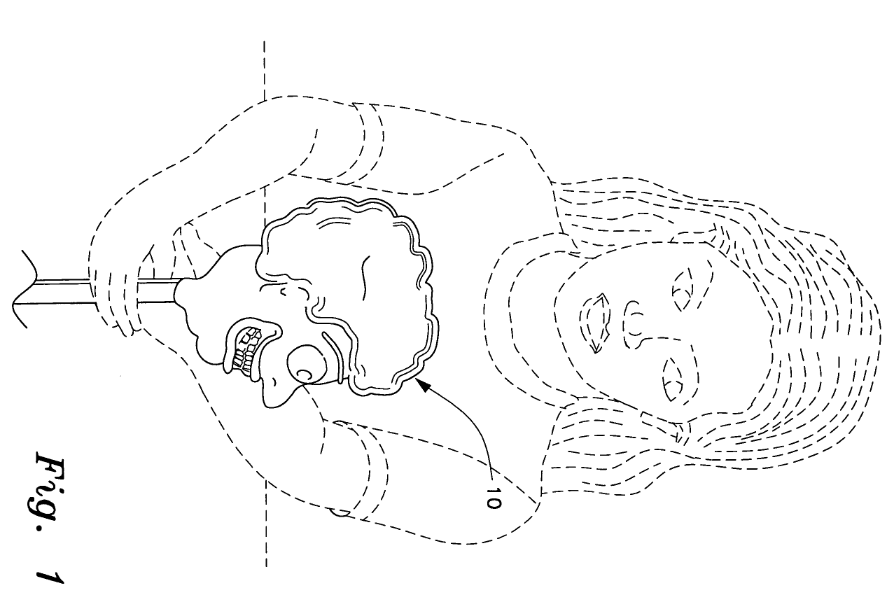

The present invention is an anatomically correct candy novelty 10, as is depicted in FIG. 1.

The anatomically correct candy novelty 10 is comprised of an exterior layer of confectionery material 20 that represents the skin and flesh of an anatomically correct human body part and an interior layer of hard candy material 30 that represents the skeleton of an anatomically correct human body part. This particular embodiment of the anatomically correct candy novelty 10 also comes on a stick 40 that will support the exterior layer of confectionery material 20 that represents the skin and flesh of a face and the interior layer of hard candy material 30 that represents a hard candy skull.

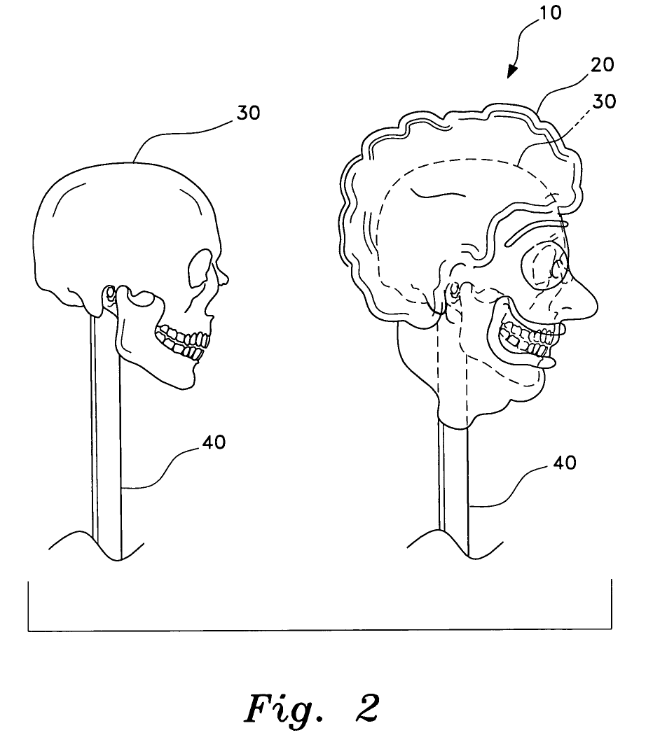

The first embodiment of the anatomically correct candy novelty 10 can more specifically be the caricature face of a cartoon character, public figure or political leader. The exterior layer 20 can be chocolate, marshmallow, or taffy set over the interior layer of hard candy material 30. This formation can be particularly interesting to children who will eat the exterior layer of confectionery material 20 and be pleasantly surprised upon reaching the interior layer of hard candy 30 near the middle of the anatomically correct candy novelty 10. The first embodiment of the anatomically correct candy novelty 10 is also depicted in FIG. 2.

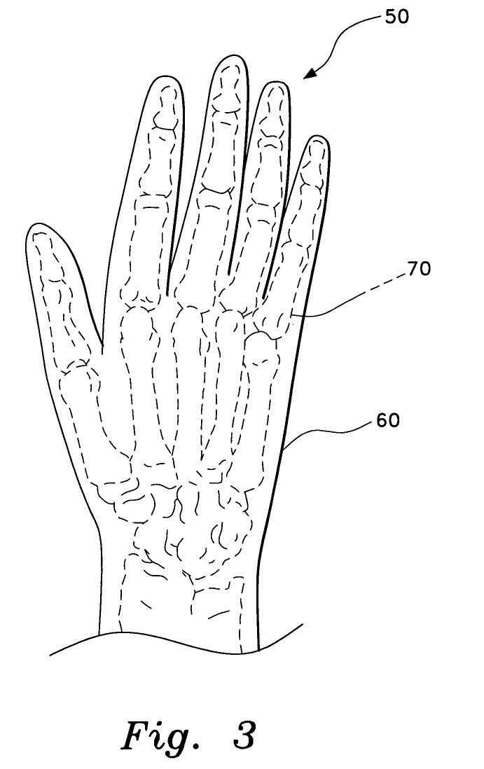

The second embodiment of the anatomically correct candy novelty 50 is in the shape of a human hand. The exterior layer of confectionery material 60 represents the skin and flesh of an actual human hand with the interior layer of hard candy material 70 making up the skeleton. Like the first embodiment of the anatomically correct candy novelty 10, the exterior layer of confectionery material 60 can also be made of chocolate, taffy or marshmallow. The second embodiment of the anatomically correct candy novelty 50 is depicted in FIG. 3.

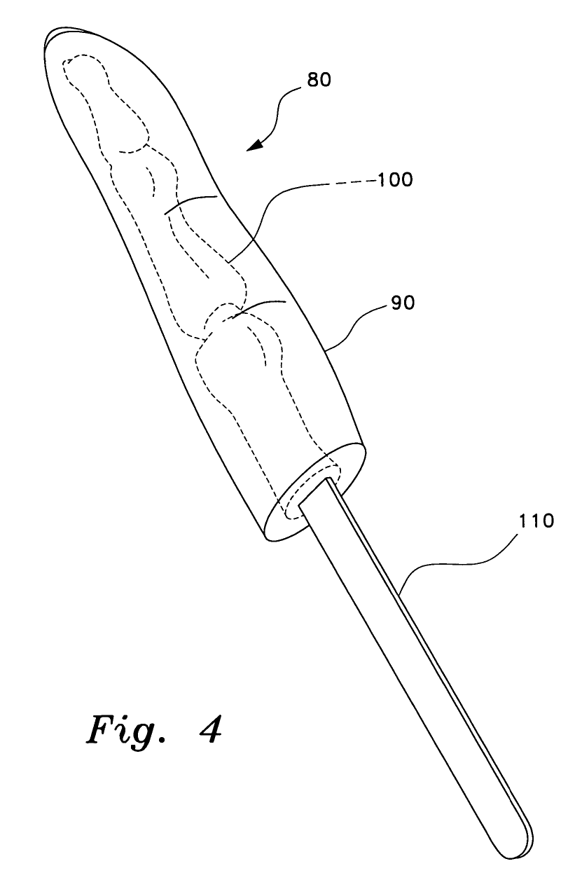

The third embodiment of the anatomically correct candy novelty 80 is in the shape of a thumb. The exterior layer of confectionery material 90 represents the skin and flesh of an actual human thumb with an interior layer of hard candy material 100 representing the bones of an actual human thumb. Like the first embodiment of the anatomically correct candy novelty 10, the exterior layer of confectionery material 60 can also be made of chocolate, taffy or marshmallow. A stick 110 is also provided with this particular embodiment of the anatomically correct candy novelty 80 that will support the exterior layer of confectionery material 90 and the interior layer of hard candy material 100. The third embodiment of the anatomically correct candy novelty 80 is depicted in FIG. 4.

Each embodiment of the anatomically correct candy novelty is not made to scale. In other words, the first embodiment of the anatomically correct candy novelty 10 is not the actual size of a human head and skull. The second embodiment of the anatomically correct candy novelty 50 is not the size of an actual human hand and the third embodiment of the anatomically correct candy novelty 80 is not the actual size of an actual human thumb. As indicated previously for each embodiment of the anatomically correct candy novelty, the exterior layers can be made of chocolate, marshmallow or taffy that represent skin and flesh will have an interior layer made of hard candy representing the skeleton or bones of the particular embodiment. Although not to scale, each embodiment does have the detailing of its actual representation of its respective human body part.

Of course, other body parts could be simulated, human or animal, and still be within the scope of the instant invention. Accordingly, the invention is in no way limited to just the three parts illustrated and above-discussed.

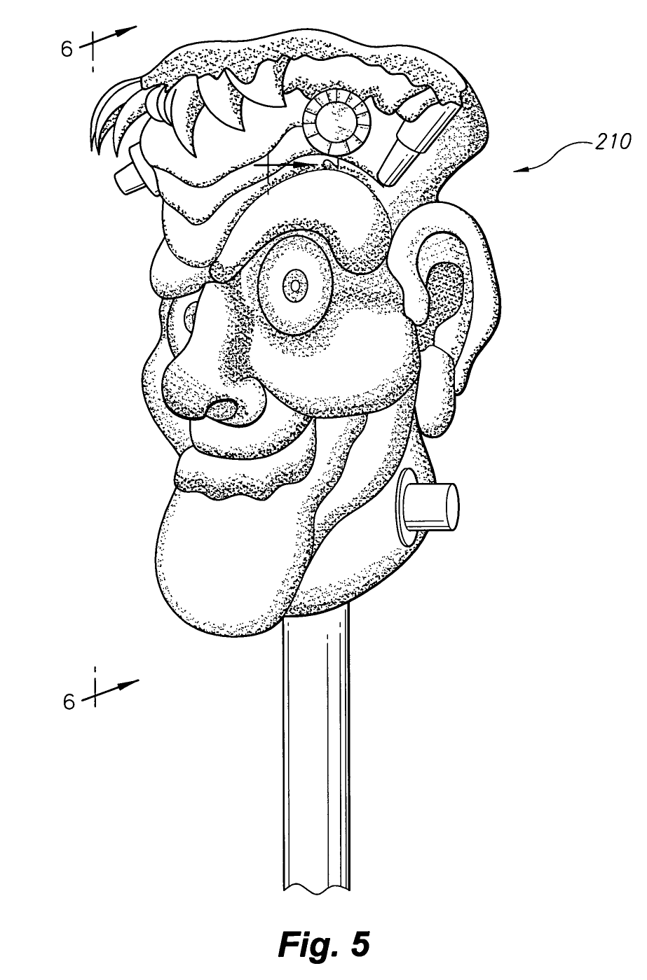

The present invention also extends to a multi-layered candy novelty Frankenstein head caricature 210, as is depicted in FIG. 5.

The multi-layered candy novelty Frankenstein head caricature 210 comprises an exterior layer of confectionery material 220 that is formed into a three-dimensional Frankenstein head caricature and an interior layer of hard candy material 230 that is formed into a flat two-dimensional skeleton head, the exterior layer of confectionery material 220 covering the entire interior layer of hard candy material 230. The interior layer of hard candy material 230 can also be formed into a three-dimensional skeleton head, the exterior layer of confectionery material 220 also covering the entire interior layer of hard candy material 230.

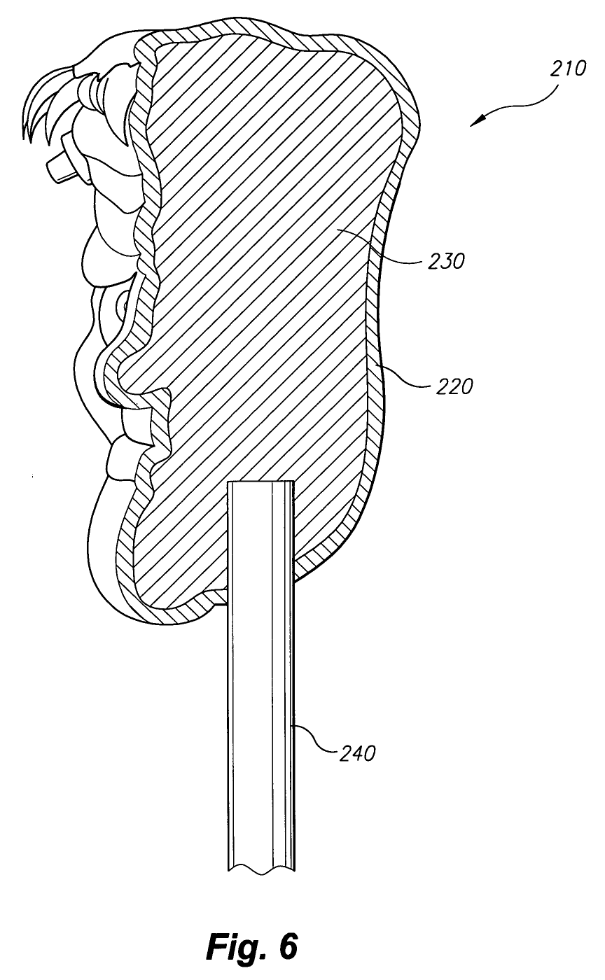

The exterior layer of confectionery material 220 of the embodiment of the multi-layered candy novelty Frankenstein head caricature 210 is made of gummi bear material. Gummi bear material is the actual gum-like confectionery or soft, gummy gelatin used to make the popular candy gummi bears. The multi-layered candy novelty Frankenstein head caricature 210 is also on a stick to form a multi-layered lollipop. The various layers of the multi-layered candy novelty Frankenstein head caricature 210 are depicted in FIG. 6.

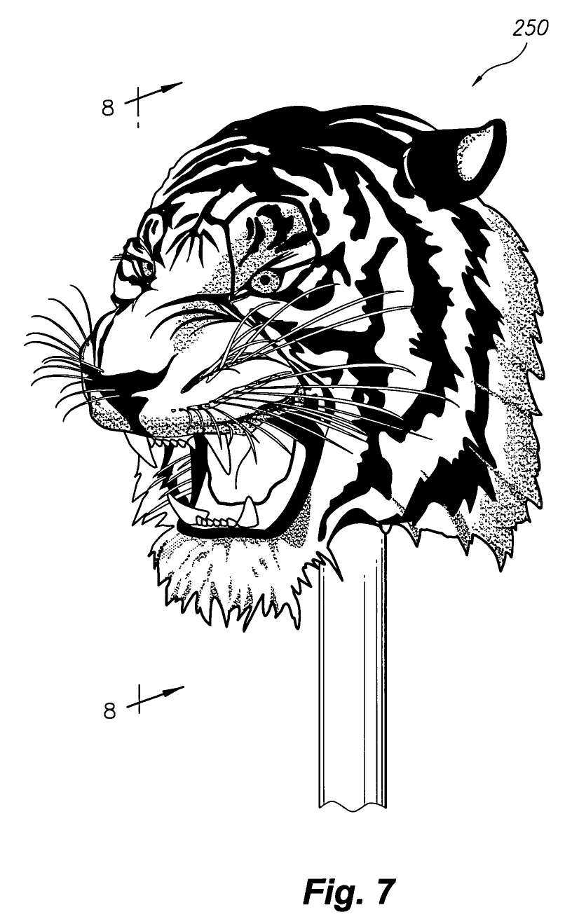

In another alternative form, the multi-layered candy novelty may be formed as a tiger head caricature 250, is shown on FIG. 7. The multi-layered candy novelty tiger head caricature 250 comprises an exterior layer of confectionery-material 260 that is formed into a three-dimensional tiger head caricature and an interior layer of hard candy material 270 that is formed into a two-dimensional tiger head skeleton, the exterior layer of confectionery material 260 covering the entire interior layer of hard candy material 270. The interior layer of hard candy material 270 can also be formed into a three-dimensional tiger head skeleton (not shown), the exterior layer of confectionery material 260 covering the entire interior layer of hard candy material 270.

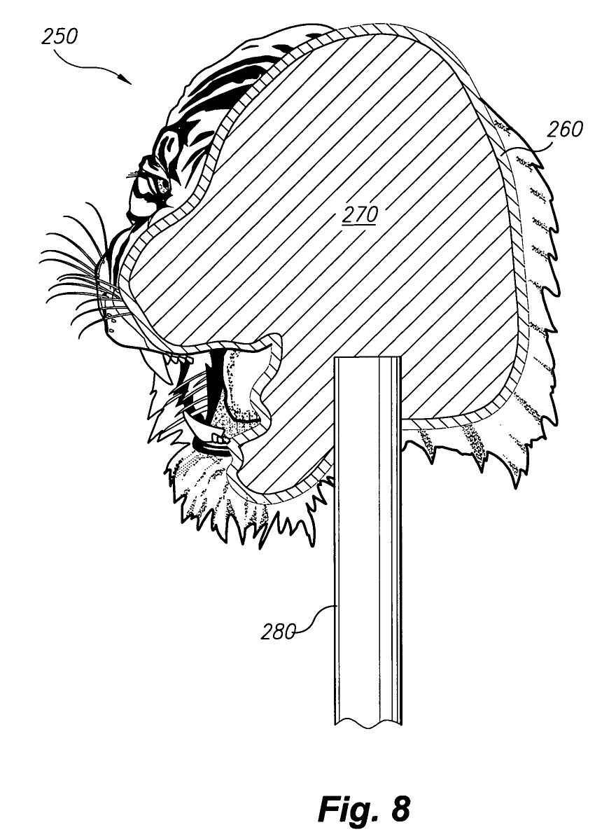

The exterior layer of confectionery material 260 of the second embodiment of the multi-layered candy novelty tiger head caricature 210 is also made of gummi bear material. Gummi bear material is the actual gum-like confectionery used to make the popular candy gummi bears. The multi-layered candy novelty tiger head caricature 250 is also on a stick 280 to form a multi-layered lollipop. The various layers of the multi-layered candy novelty tiger head caricature 250 are depicted in FIG. 8.

As in the case of the anatomically correct human body part candy novelty, the Frankenstein head 210 and the tiger head caricature 250 need not be three-dimensional, but may be two-dimensional, i.e., flat head candy confections.

It is to be understood that the present invention is not limited to the embodiments described above, but encompasses any and all embodiments within the scope of the following claims.

I claim:

1. A multi-layered candy novelty, comprising:
an interior layer made of hard candy; and
an exterior layer made from a soft confectionery material surrounding the interior layer.

2. The multi-layered candy novelty according to claim 1, wherein said exterior layer is made from chocolate.

3. The multi-layered candy novelty according to claim 1, wherein said exterior layer is made from a soft, gummy gelatin.

4. The multi-layered candy novelty according to claim 1, wherein:
said exterior layer is formed to represent the skin and flesh of an anatomically correct human body part; and
said interior layer is formed to represent a skeleton of the human body part.

5. The multi-layered candy novelty according to claim 4, wherein the anatomically correct human body part is represented in three dimensions.

6. The multi-layered candy novelty according to claim 4, wherein the anatomically correct human body part is represented in as a flat, two-dimensional representation.

7. The multi-layered candy novelty according to claim 1, wherein:
said exterior layer is formed into a caricature; and
said interior layer is formed into a skeleton of the caricature.

8. The multi-layered candy novelty according to claim 7, wherein the caricature is a Frankenstein head.

9. The multi-layered candy novelty according to claim 7, wherein the caricature is a tiger head.

10. The multi-layered candy novelty according to claim 7, wherein the caricature is represented in three dimensions.

11. The multi-layered candy novelty according to claim 7, wherein the caricature is represented in as a flat, two-dimensional representation.

12. The multi-layered candy novelty according to claim 1, further comprising a stick, said interior layer being mounted on the stick.

13. An anatomically correct candy novelty comprising:
an exterior layer of confectionery material representing skin and flesh of an anatomically correct human body part; and
an interior layer of hard candy material representing a skeleton of the anatomically correct human body part, said exterior layer covering said entire interior layer of the body part.

14. The candy novelty according to claim 13, wherein the exterior layer of confectionery material is made of chocolate.

15. The candy novelty according to claim 13, wherein the anatomically correct human body part is a face.

16. The candy novelty according to claim 13, further comprising a stick, the interior layer being mounted on the stick.
